(19) United States
(12) Patent Application Publication
(10) Pub. No.: US 2019/0283136 A1
(43) Pub. Date: Sep. 19, 2019

(54) Method Of Producing A Component With Additive Manufacturing

(71) Applicant: Weldaloy Products Company, Warren, MI (US)

(72) Inventors: Kurt David Ruppenthal, Farmington Hills, MI (US); Ramachandra Canumalla, Clinton Township, MI (US); David Anthony Clark, Chesterfield, MI (US); Dayakara Raju Perubandi, Warren, MI (US)

(73) Assignee: Weldaloy Products Company, Warren, MI (US)

(21) Appl. No.: 16/358,347

(22) Filed: Mar. 19, 2019

Related U.S. Application Data
(60) Provisional application No. 62/644,966, filed on Mar. 19, 2018.

(51) Int. Cl. B22F 3/105; B22C 9/24; B22F 3/24

(52) U.S. Cl. CPC B22F 3/1055; B33Y 10/00; B22F 3/24; B22C 9/24

(57) ABSTRACT

A method of producing a component is disclosed. The method first comprises the steps of providing a base structure having a surface, providing an exoskeleton, and positioning the exoskeleton about the surface of the base structure. Once the exoskeleton is positioned, the method further comprises the steps of depositing metallic material on the surface of the base structure having the exoskeleton thereabout with an additive manufacturing process to form an additive structure, and removing the exoskeleton to form one or more cavities within the component and complete production thereof

### CROSS REFERENCE TO RELATED APPLICATIONS

The subject application claims priority to and all the benefits of U.S. Provisional Patent Application No. 62/644,966, filed on Mar. 19, 2018, the contents of which are expressly incorporated herein in their entirety.

### TECHNICAL FIELD

The present invention relates, generally, to a method of producing components with additive manufacturing and the components produced therewith.

### BACKGROUND

Metal components of complex geometry, e.g. aerospace components, having various shapes and internal passages and cavities therein may be difficult to forge, cast, mill, machine, weld, braze, or otherwise produce. In fact, many such metal components are design limited by conventional production methods. Further, conventional production methods can be time-consuming and expensive, and can yield metal components of varying dimensional integrity and quality. In the aerospace industry, there is a need for efficient production of metal components which are complex in design, defect free, and of overall high quality.

Methods of producing metal components for the aerospace industry are known in the art. Many such methods can preclude various design features, and often yield components of inconsistent quality with respect to dimensional integrity and surface finish. For example, many thrust chambers are produced with conventional methods of production in which a copper alloy base is forged, machined, and further modified via the bonding of a nickel alloy overlay to create manifolds or cooling channels therein. Such conventional thrust chambers are essentially two piece metal components. From a metallurgical perspective, such conventional thrust chambers have a sharp gradient at a bond line from one type of material, e.g. a copper alloy base, to another, e.g. a nickel alloy overlay.

Such conventional methods of producing thrust chambers are complex and require long lead times. Further, such conventional methods produce lower yields and metal components of inconsistent quality. For example, the machining of the cooling channels during production of the thrust chamber with such conventional methods can be time consuming and provide cooling channels with limited dimensional tolerances. Further, because the nickel alloy overlay used in the production of the thrust chamber with these conventional methods is cast and bonded to the copper base to complete the formation of the cooling channels, various fit and finish issues associated with overlay's dimensional tolerances are introduced and a potential failure mode is created at the bond line where the copper base and the nickel alloy overlay interface. As such, such conventional methods of production can limit the yield and quality of the thrust chambers produced. In aerospace applications, high quality parts of excellent fit, form, and finish are required because of stringent specification requirements and a focus on flight safety.

To this end, while many methods of metal component production are known in the related art and have generally performed well for their intended purpose, there remains a need in the art for improved methods of production of metal components which do not limit design features and efficiently produce high quality metal components (i.e. having excellent fit, form, and finish) which are complex in design, defect free, and have enhanced mechanical and metallurgical properties. There is also a need for improved methods of production which include in-situ quality control techniques to ensure the consistent production of high quality metal components which are complex in design, defect free, and have enhanced mechanical and metallurgical properties.

### SUMMARY OF THE INVENTION

A method of producing a component is disclosed herein. The method first comprises the steps of providing a base structure having a surface, providing an exoskeleton, and positioning the exoskeleton about the surface of the base structure. Once the exoskeleton is positioned, the method further comprises the steps of depositing metallic material on the surface of the base structure having the exoskeleton thereabout with an additive manufacturing process to form an additive structure, and removing the exoskeleton to form one or more cavities within the component and complete production thereof

In many embodiments, the method of this disclosure mitigates traditional two piece metal components and replaces them with a single integrated metal component. From a metallurgical perspective, the sharp gradient of traditional two piece metal components is replaced with a single integrated component which has a controlled gradient from one type of material, e.g. a copper alloy, to another, e.g. a brass alloy.

In this way, the method affords advantages for efficiently producing high quality metal components such as those used in aerospace. In some embodiments the method can be employed to solve manufacturing challenges associated with the production of thrust chambers. For example, in many embodiments, the use of the exoskeleton, the formation of the additive structure with the additive manufacturing process, and the removal of the exoskeleton to form the cooling channels in the thrust chamber eliminates problems associated with the use of machining and an overlay to form cooling channels. Further, the formation of the additive structure with the additive manufacturing process eliminates problems associated with an interface between a base of one material, e.g. copper, and overlay of another, e.g. nickel which is associated with the use of machining and an overlay to form cooling channels. In such embodiments, the method efficiently yields thrust chambers of complex design which are defect free and have enhanced mechanical and metallurgical properties.

### BRIEF DESCRIPTION OF THE DRAWINGS

Advantages of the present invention will be readily appreciated as the same becomes better understood by reference to the following detailed description when considered in connection with the accompanying drawings.

FIG. 1 is a side view of a thrust chamber produced with the method of the subject disclosure.

FIG. 2 is a process diagram which illustrates the production of the thrust chamber of FIG. 1 with one particular embodiment of the method of the subject disclosure.

FIG. 3A is a cross-sectional view taken across line A-A of FIG. 2, Step 5.

FIG. 3B is an isolated slice section view taken along line A-A of FIG. 2, Step 5.

FIG. 4 is an isolated side view of the rib of FIG. 3B.

FIG. 5A is a cross-sectional view of the thrust chamber including a core and an exoskeleton.

FIG. 5B is a slice section view taken along line A-A of the thrust chamber including the core and the exoskeleton of FIG. 2, Step 5.

FIG. 5C is a cross-sectional view of the core of FIG. 5A.

FIG. 5D is an isolated view of the core of FIG. 5A which includes an upper core portion and a lower core portion.

FIG. 6A is a cross-sectional view taken across line B-B of FIG. 2, Step 6.

FIG. 6B is an isolated slice section view taken along line B-B of the base structure having the exoskeleton thereabout and the additive structure disposed thereon of FIG. 2, Step 6.

FIG. 7A is a cross-sectional view taken across line C-C of FIG. 2, Step 7.

FIG. 7B is an isolated slice section view taken along line C-C of the base structure having the exoskeleton removed and thus including cooling (i.e. an isolated slice section view of the thrust chamber formed with the method and shown in FIG. 2, Step 7).

FIG. 8A is an exploded perspective view of the thrust chamber having a core within which secures the exoskeleton in place during the step of dispensing/additive manufacturing.

FIG. 8B is an isolated perspective view of the core of FIG. 8A.

FIG. 9 is a flow chart which illustrates the process diagram of FIG. 2.

### DETAILED DESCRIPTION

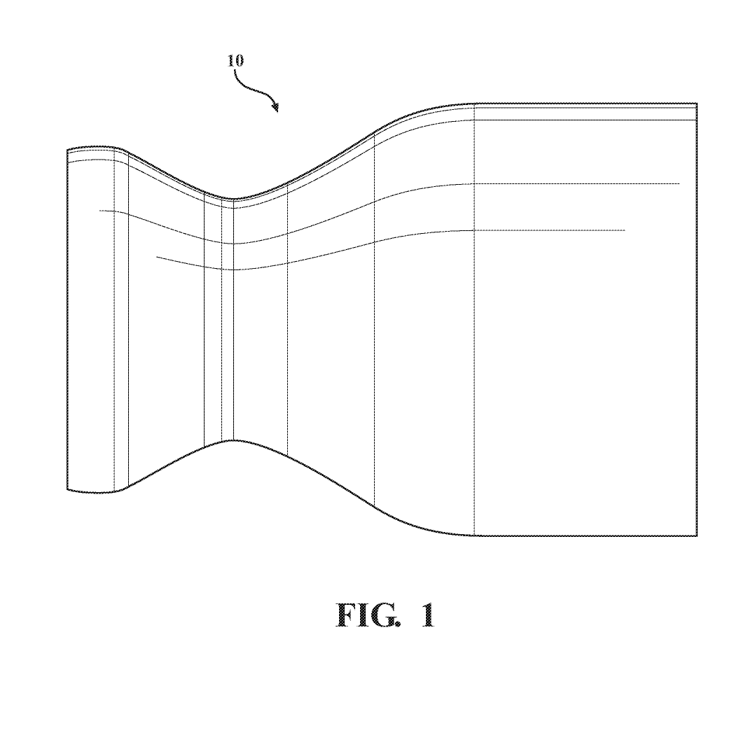

A method of producing a component, e.g. a metal aerospace component such as a thrust chamber, is disclosed herein. Referring now to the drawings, wherein like numerals indicate corresponding parts throughout the several views, the method is generally shown at 8 and the component is generally shown at 10. The component 10 includes a base structure, generally indicated at 12, and an additive structure 14 integral with the base structure 12. In the representative embodiments illustrated herein and depicted throughout the drawings, the component 10 is exemplified as a thrust chamber 10 which includes the base structure 12 and an additive structure 14 integral with the base structure 12. FIG. 1 is a side view of a thrust chamber 10 produced with the method 8 of the subject disclosure. Those having ordinary skill in the art will appreciate that the component 10 could be realized in a number of different configurations/designs, in a number of different components 10, for different applications or for different industries, without departing from the scope of the present invention. In many embodiments, the component 10 is a thrust chamber, nozzle, or other metal component 10 of complex shape and size which is used in the aerospace industry. In many other embodiments, the component 10 is produced for use in the transportation, oil and gas, power equipment, semiconductor, material processing, and utility/energy production industries.

The method 8 first comprises the steps of providing the base structure 12 having a surface 16, providing an exoskeleton 18, and positioning the exoskeleton 18 about the surface 16 of the base structure 12. Once the exoskeleton 18 is positioned on the surface 16 of the base structure 12, the method 8 further comprises the steps of depositing metallic material on the surface 16 of the base structure 12 having the exoskeleton 18 disposed thereabout with an additive manufacturing process to form the additive structure 14 which is integral with the base structure 12. Once the additive structure 14 is formed, the exoskeleton 18 (now technically an endoskeleton) is removed to produce the component 10. To this end, the component 10 produced includes the base structure 12 and the additive structure 14 and defines one or more cavities 20 where the exoskeleton 18 was removed.

The method 8 includes the step of providing a base structure 12 having a surface 16. The base structure 12 typically comprises, consists essentially of, consists of, or is metal. In many embodiments, the metal is selected from copper, nickel, aluminum, tin, titanium, lead, zinc, brass, Inconel alloys, and other non-ferrous metals and alloys. In some embodiments, the metal is selected from alloy steel, mild steel, carbon steel, medium carbon steel, high carbon steel, stainless steel, high speed steel, cast iron, wrought iron, and other ferrous metals and alloys. Of course, the metal can be an alloy or a combination of any of the aforementioned non-ferrous and ferrous metals. In some embodiments, the base structure 12 comprises, consists essentially of, consists of, or is copper or an alloy thereof, an Inconel alloy, and stainless steel. In some embodiments, the metal is copper or an alloy thereof. In other embodiments, the metal is nickel or an alloy thereof, such as an Inconel alloy. The step of providing the base structure 12 can include one or more of the following sub-steps: sawing, forging, machining, polishing, and surface treatment such as heat treating.

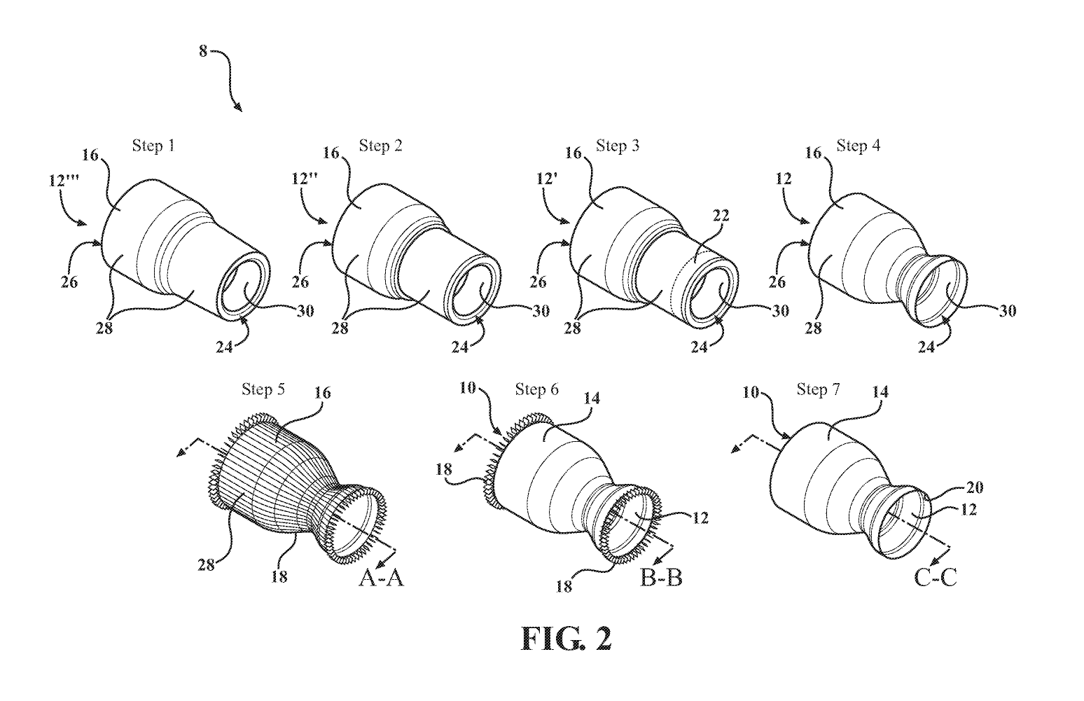

In many embodiments, the base structure 12 is typically a free form forged structure 12. To this end, the step of providing the base structure 12 may include the sub-steps of forging and machining a blank to form the base structure 12. For example, in some embodiments, the step of providing the base structure 12 includes rough forging a blank to form the base structure 12′″ with a test bar 22, rough machining the base structure 12″, removing the test bar 22 from the base structure 12′, and final machining of the base structure 12. The method 8 of one such embodiment is shown in FIG. 2. The test bar 22 (essentially a slice off of a front end 24) is removed to test the quality of the component 10 (more particularly the base structure 12). Once removed, the metal of the test bar 22 is analyzed for quality purposes (e.g. physical property testing such as tensile strength, yield, and/or elongation testing is conducted).

In some embodiments, the method 8 further comprises the step of treating the surface 16 of the base structure 12 prior to the step of depositing via additive manufacturing. During the step of treating the surface 16, the surface 16 is cleaned and/or chemically treated to promote better adhesion of the metallic material to the base structure 12. In various embodiments, the step of treating the surface 16 of the base structure 12 prior to the step of depositing via additive manufacturing is further defined as including one or more of the following: detergent cleaning, solvent cleaning, mechanical cleaning, chemical cleaning, and priming. Solvent cleaning can be accomplished by contact with a solvent-moistened cloth, immersion in the solvent, or by exposure to the solvent vapor. In some embodiments, a ketone, such as methyl ethyl ketone, can be used to clean the surface 16 of the base structure 12 prior to the step of depositing via additive manufacturing. Solvent cleaning should precede any mechanical or chemical surface treatment. Mechanical cleaning also includes a number of much faster abrading methods such as sanding, sandblasting, tumbling, etching, and abrading with power tools. Chemical cleaning can include acid cleaning/etching or anodization or electrochemical modification of the surface 16. One non-limiting example of the step of treating the surface 16 of the base structure 12 would be immersion of a base structure 12 comprising copper in a solution comprising copper ferric chloride, nitric acid, and distilled water and subsequent air drying of the base structure 12 comprising copper. Another non-limiting example of the step of treating the surface 16 of the base structure 12 would be ultrasonic cleaning/ultrasonic impact treatment (“UIT”) of the surface 16 of the base structure 12. UIT is a metallurgical processing technique in which ultrasonic energy is applied to a metal object.

The method 8 also includes the step of providing the exoskeleton 18, and positioning the exoskeleton 18 about the surface 16 of the base structure 12. The exoskeleton 18 can be fabricated from any material known in the art which can withstand the stresses (e.g. high temperature, etc.) induced via additive manufacturing, but which can also be removed to form the one or more cavities 20 within the component 10. In a preferred embodiment, the exoskeleton 18 comprises ceramic. In many embodiments, ceramic exoskeletons 18 are utilized as sacrificial structures for forming one or more cavities 20 that are too small or complex to be machined. In many embodiments, the ceramic is porous and comprises silica, alumina, and zircon. The exoskeleton 18 is engineered to create the one or more cavities 20 of a specific shape within the component 10. The exoskeleton 18 can include one or more parts and can be extruded, molded, or even deposited on the surface 16 of the base structure 12 via additive manufacturing. In one embodiment, the steps of providing and positioning the exoskeleton 18 are conducted concurrently with an additive manufacturing system, a three-dimensional printing process, or the like. In another embodiment, the exoskeleton 18 is a multi-piece exoskeleton 18 which is molded and positioned with the use of a core 36 or other positioning element.

Once the exoskeleton 18 is positioned, the method 8 further comprises the step of depositing a metallic material on the surface 16 of the base structure 12 having the exoskeleton 18 thereabout with an additive manufacturing process to form an additive structure 14. In some embodiments, the metallic material comprises, consists essentially of, consists of, or is aluminum or alloys thereof, cobalt or alloys thereof, tool steels, nickel or alloys thereof, stainless steels, titanium or alloys thereof, gold or alloys thereof, silver or alloys thereof, and copper or alloys thereof. In one embodiment, the metallic material is cobalt or an alloy thereof.

There are a number of metal additive manufacturing systems known in the art, any of which can be used for the step of depositing a metallic material on the surface 16 of the base structure 12 having the exoskeleton 18 thereabout with an additive manufacturing process to form an additive structure 14.

Metal additive manufacturing systems known can be classified by the energy source or the way the material is being joined, for example using a binder, laser, heated nozzle, etc. Classification is also possible by the group of materials being processed, such as plastics, metals or ceramics. The feedstock state, with the most common ones being solid (powder, wire or sheet) or liquid, is also used to define the process. In many embodiments, the additive manufacturing process is selected from a liquid, a sheet, a wire, or a powder process. In some embodiments, the additive manufacturing process is a laser melting powder process. The laser melting process can be a powder-fed additive manufacturing process or a powder-bed additive manufacturing process.

In embodiments where the additive manufacturing process is a powder additive manufacturing system, the method 8 comprises the steps of:

(1) depositing the metallic material on the surface 16 of the base structure 12 and melting the metallic powder to form a layer of the metallic material;

(2) depositing a metallic powder on a surface of the layer and/or a surface of the exoskeleton 18 and melting the metallic powder to form a subsequent layer of the metallic material; and

(3) repeating the second step (2) one or more times to form the additive structure 14 having a specific composition and geometry.

In a typical embodiment, powder-bed additive manufacturing systems deposit/distribute a powder layer having a thickness of from about 5 to about 300, alternatively from about 10 to about 100, μm onto a surface or substrate. Once the powder layer is distributed, a 2D slice is either bound together, known as 3D-printing, or melted using an energy beam applied to the powder bed. In a typical embodiment, the energy source is one high-power laser, but some embodiments use two or more lasers with different power under inert gas atmosphere. In some embodiments, the energy source is an electron beam, e.g. electron-beam additive manufacturing, electron-beam melting (EBM) additive manufacturing, or 3D printing, that is used to build the additive structure 14. In other embodiments, the energy source is a laser, e.g. an additive manufacturing processes employing a laser such as LIVID (Laser Metal Deposition) and Selective Laser Melting (SLM), that is used to build the additive structure 14. The term 3D printing initially referred to another non-laser process known as Fused Deposition Modelling (FDM) but this term has recently been popularized and is now sometimes used to refer to the whole industry.

Selective Laser Melting (SLM) or the closely related Selective Laser Sintering (SLS) differ only in that in SLM complete melting of the powder is achieved as opposed to simply fusing the powder together as happens in the SLS technique. The depositing and melting process is repeated slice by slice, layer by layer, until the last layer is melted and the additive structure 14 is formed. The component 10 is then removed from the powder bed and post processed as required.

Although powder-fed systems use the same feedstock as powder-bed systems, the way the material is added layer by layer differs from that of a powder-bed system. In a typical embodiment of a powder-fed system, powder flows through a nozzle being melted from a beam right on the surface of the treated part.

In some embodiments, the metallic material is in the form of a powder and comprises, consists essentially of, consists of, or is aluminum or alloys thereof, cobalt or alloys thereof, tool steels, nickel or alloys thereof, stainless steels, titanium or alloys thereof, gold or alloys thereof, silver or alloys thereof, and copper or alloys thereof. A number of machine manufacturers offer their own proprietary metallic materials. In one embodiment, the metallic material is cobalt or an alloy thereof In many such embodiments, the metallic material powder has a mean particle size of from about 1 to about 100, alternatively from about 5 to about 50, alternatively from about 10 to about 50, μm. In various non-limiting embodiments, all values and ranges of values including and between those described above are hereby expressly contemplated for use herein.

Selection of the metallic material impacts the mechanical and metallurgical properties of the component 10 including tensile strength, hardness, elongation, and temperature resistance. As such, the metallic material will be selected based on the component 10 being produced as well as the application and industry in which the component 10 is being used in.

In some embodiments, the step of depositing and melting is conducted with one or more different types of metallic powder. That is, the different layers which are used to form the additive structure 14 can be formed with different types of metal material, e.g. metallic powder. In some embodiments, the metallic material powder is deposited at a thickness of from about 5 to about 300, alternatively from about 20 to about 100, μm. In various non-limiting embodiments, all values and ranges of values including and between those described above are hereby expressly contemplated for use herein. Of course, in various embodiments, the additive manufacturing process can be optimized via changing various process parameters such as the direction of the powder deposition, the spinning of the part, pre-heating of the powder, the rate of deposition, power density, beam power (total), feedstock feed rate, melt puddle travel speed, minimum time between subsequent layers for any given location substrate thickness, deposit length, deposit height, deposit width, deposit angle in relation to substrate, build path (single, multiple, cross-hatched), intersection type and direction, intersection angle, intersection individual length, height, and width, and/or minimum arc radius. In some embodiments, the metallic powder is applied and/or the laser is used in a direction which is substantially parallel to the walls of the exoskeleton 18. In other embodiments, the metallic powder is applied and/or the laser is used in a direction which is substantially perpendicular to the walls of the exoskeleton 18. For example, in embodiments where a thrust chamber 10 is being manufactured and the exoskeleton 18 includes a plurality of ribs which are positioned on an outer peripheral surface 28 of the base structure 12, the powder is applied and/or the laser is used in a direction which is substantially perpendicular to the walls of the exoskeleton 18, i.e. in a direction perpendicular to the ribs of the exoskeleton 18.

As is set forth above, the depositing and melting process is repeated slice by slice, layer by layer, until the last layer is melted and the additive structure 14 is formed. In some embodiments, the method 8 further comprises the step of measuring the optical electromagnetic emissions of the melted metallic powder during the formation of each layer. In many such embodiments, an optical fiber probe is used to capture the optical electromagnetic emissions and characterize each layer. For example, the step of measuring the optical electromagnetic emissions of the melted metallic powder during the formation of each layer can be conducted to ensure a controlled gradient between two different metals. That is, in embodiments where a copper alloy base is being transitioned into a nickel alloy, a distinct gradient can be characterized via the step of measuring the optical electromagnetic emissions which can be repeated as the depositing and melting process is repeated slice by slice, layer by layer, until the last layer is melted and the additive structure 14 is formed. To this end, the gradient can be characterized, for example from about 100:0, 90:10, 80:20, 70:30, 60:40, 50:50, 40:60, 30:70, 20:80, 10:90, or 0:100. The gradient itself can be optimized to ensure excellent metallurgical properties and minimize the risk associated with an abrupt transition from one material, e.g. copper, to a different material, e.g. nickel. Further, various gradients are hereby expressly contemplated for use herein.

That said, the gradient can be engineered with one or more layers. For example, a gradient can be engineered and tested, the gradient having three layers: (1) 70:30 layer, (2) 50:50 layer, and (3) 30:70 layer when transitioning from the base structure 12 into the additive structure 14.

Alternatively or in addition to the step of measuring the optical electromagnetic emissions of the melted metallic powder during the formation of each layer, the method 8 can include the step of taking an image (e.g. a computer tomography (“CT”) scan) of the melting metallic powder during the formation of each layer, or once each layer is formed. The step of taking one or more CT scans during the step of depositing the metallic material on the surface 16 of the base structure 12 having the exoskeleton 18 thereabout with an additive manufacturing process to form an additive structure 14 allows for the identification and/or verification of the existence of pores, cavities, fissures, form deflection, displacement, shape distortion, etc. Of course, a CT scan can be taken once the additive structure 14 is formed, to visualize, measure, and assess wall thickness and the dimensions of inner and outer structures, all relative to product requirements.

For example, the step of measuring and taking an image can be further defined as taking a cross-sectional, three-dimensional image of an internal body part, e.g., CT scan of the melting metallic powder during the formation of each layer, or once each layer is formed. If the image reveals any quality defects, e.g. voids, in a layer, the method 8 can be stopped and the layer can be removed, e.g. machined off of the part. Once removed, the method 8 can resume with the quality defect being removed. Such in-situ quality analysis allows for the recognition of a quality defect and its removal (before the part is complete), which insures excellent metallurgical quality and also optimum process efficiency.

In alternative embodiments, high-resolution microscopy techniques including X-ray microscopy, optical microscopy, scanning electron and focused ion beam microscopy can be used to characterize and analyze the metal powder, the additive structure 14 and the component 10. In one such embodiment, scanning electron microscopy (SEM) is used to take image(s). These high-resolution microscopy techniques can also be used to characterize the properties of the metal powder, e.g. determine particle size and size distribution, agglomerations, size (roundness), all of which impacts the ability of powder to flow, which in-turn impacts product quality.

In embodiments of the method 8 including the step of taking an image (e.g. a computer tomography (CT) scan) of the melting metallic powder during the formation of each layer, or once each layer is formed, or once the additive structure 14 is formed, the measurements and/or images are collectively used to characterize the porosity, cracking, grain, and homogeneity, and dimensional accuracy of the additive structure 14 and/or the component 10.

Once the additive structure 14 is formed, the method 8 further comprises the step of removing the exoskeleton 18 to form the one or more cavities 20 within the component 10 and complete production of the component 10. In a typical embodiment, the step of removing the exoskeleton 18 to form the component 10 is further defined as disintegrating, breaking, and/or dissolving the exoskeleton 18. For example, in one embodiment, the exoskeleton 18 comprises ceramic having wire running therethrough (e.g. comprising wire reinforced ceramic) and the force is applied to the wire (e.g. the wire is tugged on) to break and remove the wire and ceramic from the component 10 and form the one or more cavities 20 therein. In other words, an exoskeleton 18 comprising ceramic cores with wire embedded within the core gives rigidity, stability, ease in handling, and dimensional integrity to the exoskeleton 18 and allows for the breaking out of the ceramic by pulling the wire after the exoskeleton's 18 purpose of making the one or more cavities 20 is over.

The wire (within the ceramic core) allows for the breaking out of the ceramic exoskeleton 18 (it can be pulled) once the additive structure 14 is formed, to form one or more cavities 20 therein. The wire can have a cross-sectional profile of any suitable configuration, such as a circle, an oval, or any type of ellipse, a closed parabolic shape, a quadrilateral, or any other type of polygon for added removal efficiency. In one embodiment, the cross-sectional profile of the wire is circular. In another embodiment, the cross-sectional profile of the wire is rectangular (e.g. ribbon-like). In some embodiments, the wire can be “cork-screwed”, “kinked”, “barbed”, or shaped other than straight for added removal efficiency. The diameter of the wire can vary depending on the component 10 and/or application.

Advantageously, the wire reinforced ceramic cores also provide the exoskeleton 18 with rigidity, flexibility, and dimensional integrity and stability, which is important when intricate cavities 20 are being formed (e.g. cooling channels). As another example, the exoskeleton 18 comprises ceramic which is broken ultrasonically and subsequently removed from the component 10 to form the one or more cavities 20 therein. As yet another example, the step of removing the exoskeleton 18 to form the component 10 is further defined as chemical breaking down, dissolving, or otherwise altering the exoskeleton 18 and subsequent removal from the component 10 to form the one or more cavities 20 therein.

In some embodiments, once the exoskeleton 18 is removed from the component 10 to form one or more cavities 20 therein, the surfaces of the component 10, which were formed by the exoskeleton 18 and define the one or more cavities 20, can be polished with a polishing process selected from abrasive slurry polishing, chemical polishing, electro polishing, and combinations thereof

In some embodiments, once the exoskeleton 18 is removed from the component 10 to form the one or more cavities 20 therein, the surfaces of the component 10 (including the surfaces created by or of the additive structure 14) can be post processed. In some embodiments, to achieve the desired specifications or improve properties such as mechanical properties, metallurgical properties, dimensional accuracy, and surface finish quality, the method 8 includes one or more post processing steps to produce the component 10. For example, the use of many metal-machining finishes may be required to meet the requirements of surface quality and geometry desired for the component 10.

Further, the component 10 can be milled, drilled, polished, etc. In some embodiments, internal surfaces, such as those defining the one or more cavities 20, for example, are polished using abrasive flow machining. As another example, heat treatment is often included in the method 8 and/or shot peening to improve the mechanical and metallurgical properties of the surfaces of the component 10.

Some embodiments of the method 8 include the post process of electro polishing, as this electrochemical treatment significantly improves the surface finish of the component 10. The objectives of electro polishing include deburring, minimization of micro roughness, brightening, and passivating. Many embodiments include the post processing step of surface treating surfaces of the component 10 via one or more of the following: detergent cleaning, solvent cleaning, mechanical cleaning, chemical cleaning, and priming. Even the surfaces which define the one or more cavities 20 can be surface treated. Such surface treatments are described above.

Referring again to FIG. 1, in some embodiments, the base structure 12 is a tapered cylindrical structure having the front end 24 and a back end 26, wherein the surface 16 includes the outer peripheral surface 28 and an inner peripheral surface 30, and wherein the inner peripheral surface 30 defines a chamber. FIG. 2 is a flow diagram which illustrates the production of the thrust chamber 10 of FIG. 1 with one particular embodiment of the method 8 of the subject disclosure.

The embodiment of the method 8 shown in FIG. 2 includes the steps of (2-1) rough forging a copper blank to form the base structure 12′″ with a test bar 22, (2-2) rough machining the base structure 12″, (2-3) removing the test bar 22 from the base structure 12′, and (2-4) final machining of the base structure 12. Once formed, the exoskeleton 18 is provided and positioned about the surface 16 of the base structure 12 (2-5). From a number perspective, (2-1) is short for FIG. 2, Step 1, so on and so forth.

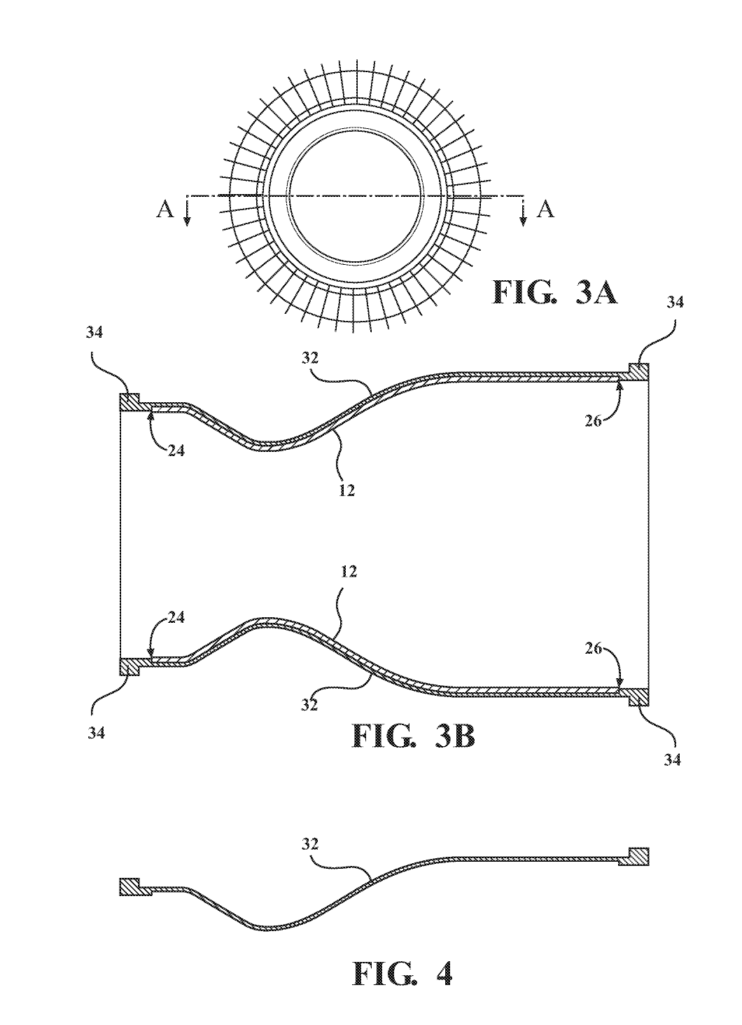

In the embodiment of FIG. 2, the exoskeleton 18 includes a plurality of ribs 32 configured to be positioned about the outer peripheral surface 28 of the base structure 12. In this embodiment, the exoskeleton 18 includes the plurality of ribs 32 configured to be positioned on the outer peripheral surface 28 of the base structure 12, wherein, once positioned, the plurality of ribs 32 are linear and substantially parallel and extend from the front end 24 to the back end 26 of the base structure 12. Of course, the plurality of ribs 32 are shaped to the contours of the outer peripheral surface 28 of the base structure 12 and, as such, sit flush on the outer peripheral surface 28 of the base structure 12 as is illustrated in FIG. 3A, which is a cross-sectional view taken across line A-A in Step 5 in FIG. 2, and in FIG. 3B, which is a slice section view taken along line A-A in Step 5 of FIG. 2. FIG. 4 is an isolated side view of the rib 32 of FIG. 3B.

Each rib 32 can have any desired cross-sectional profile including cross-sectional profiles selected from rectangular, square, ovular, circular, triangular and other. The cross-sectional profile of each individual rib 32 can vary in size or shape and the cross-sectional profile of each individual rib 32 can vary in size or shape from rib 32 to rib 32.

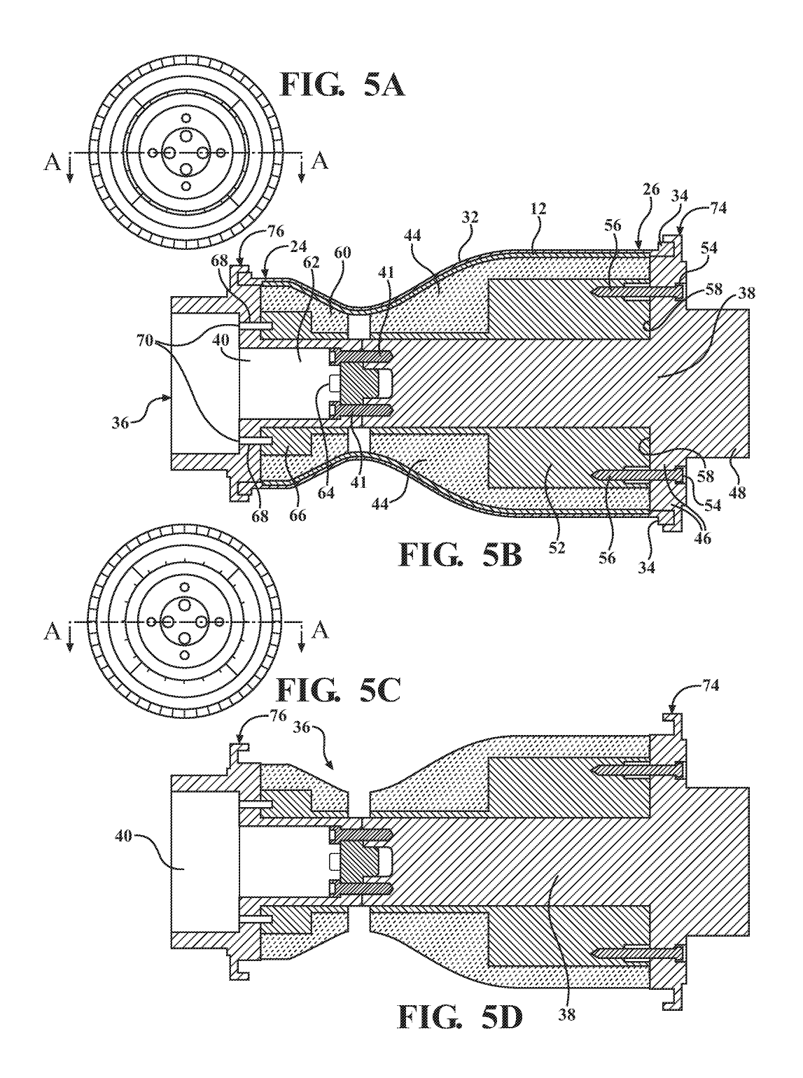

Referring now to FIGS. 5A and 5B, in some embodiments of the method 8, the core 36 is used to position the exoskeleton 18 in place on the outer peripheral surface 28 of the base structure 12. FIG. 5A is a cross-sectional view of the thrust chamber 10 including the core 36 and the exoskeleton 18, and FIG. 5B is a slice section view taken along line A-A of Step 5 of FIG. 2 with the core 36 securing the exoskeleton 18 in place. As is shown throughout the Figures, a portion 34 of the exoskeleton 18 extends past the front and back ends 24, 26 of the base structure 12. In some such embodiments, the step of positioning the exoskeleton 18 about the surface 16 of the base structure 12 is further defined as positioning the exoskeleton 18 about an outer peripheral surface 28 of the base structure 12 and inserting the core 36 into the chamber, the core 36 is shaped to fit into the chamber and configured to be coupled to the exoskeleton 18 and hold the exoskeleton 18 in place during the additive manufacturing process and formation of the additive structure 14.

As is shown in FIGS. 5A and 5B, the core 36 comprises one or more pieces or portions configured to be coupled together and shaped to fit into the chamber. That is, the core 36 is shaped to fit the inner peripheral surface 30 of the base structure 12 which defines the chamber. The one or more pieces of the core 36 can comprise metal, ceramic, and/or polymer.

In the embodiment of FIGS. 5A-5D, the core 36 comprises a lower core portion 38 (shown comprising ceramic and metal) and an upper core portion 40 (shown comprising ceramic and metal). The lower and upper core portions 38, 40 are configured to be connected with a connection mechanism such as bolts 41, as shown.

In the embodiment of FIGS. 5A-5D, the lower core portion 38 comprises multiple parts. The lower core portion 38 comprises a lower thermal blanket 44 (as shown comprising ceramic) and a lower support fixture 46 (as shown comprising multiple components, some of which comprise steel). The lower thermal blanket 44 thermally insulates the base 12 and also functions to minimize thermal expansion of the core 36. The lower support fixture 46 includes a lower fixture base 48, a lower thermal blanket carrier 52, springs 54, and shoulder bolts 56. The springs 54, shoulder bolts 56, and a gap 58 are configured to prevent damage during the insertion of the core 36 into the base structure 12 and mounting of the assembly (including the component 10 under production and the core 36) on the support mount (not shown) as well as to provide relief from dimensional variation of the core 36 and/or the base structure 12. The lower support fixture 46 is configured to attach to a fixture mount (not shown) which holds the assembly in place, and allows for the rotation and manipulation of the assembly. Still referring to FIGS. 5A-5D, the core 36 comprises the upper core portion 40 (shown comprising ceramic and metal). The upper core portion 40 includes an upper thermal blanket 60 (as shown comprising ceramic) and an upper support fixture 62 (as shown comprising multiple components, some of which comprise steel). The upper thermal blanket 60 thermally insulates the base 12 and also functions to minimize thermal expansion of the core 36. The upper support fixture 62 includes an upper fixture base 64, an upper thermal blanket carrier 66, springs 68, and shoulder bolts 70. The springs 68, shoulder bolts 70, and a gap 72 are configured to prevent damage during the insertion of the core 36 into the base structure 12 and mounting of the assembly (including the component 10 under production and the core 36) on the support mount (not shown), as well as to provide relief from dimensional variation of the core 36 and/or the base structure 12.

The upper support fixture 62 of the upper core portion 40 is configured (in this case with multiple parts) so that the lower and upper core portions 38, 40 can be connected with a connection mechanism such as bolts 41, as shown.

In FIGS. 5A-5D, the lower core portion 38 and the upper core portion 40 also comprise a lower core retainer 74 and an upper core retainer 76. The lower and upper core retainers 74, 76 are configured to be coupled to the exoskeleton 18. That is, lower and upper core retainers 74, 76 of the core 36 are configured to be coupled to the exoskeleton 18 and hold the exoskeleton 18 in place on the surface 16 of the base structure 12 during the additive manufacturing process and formation of the additive structure 14.

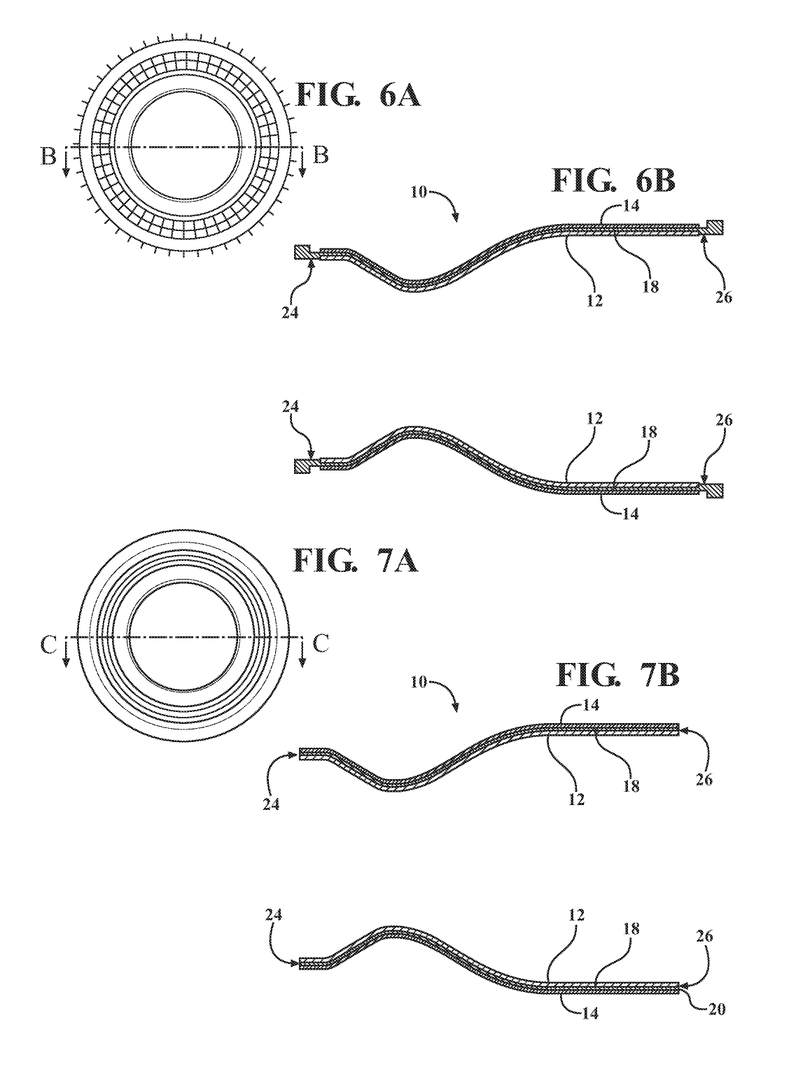

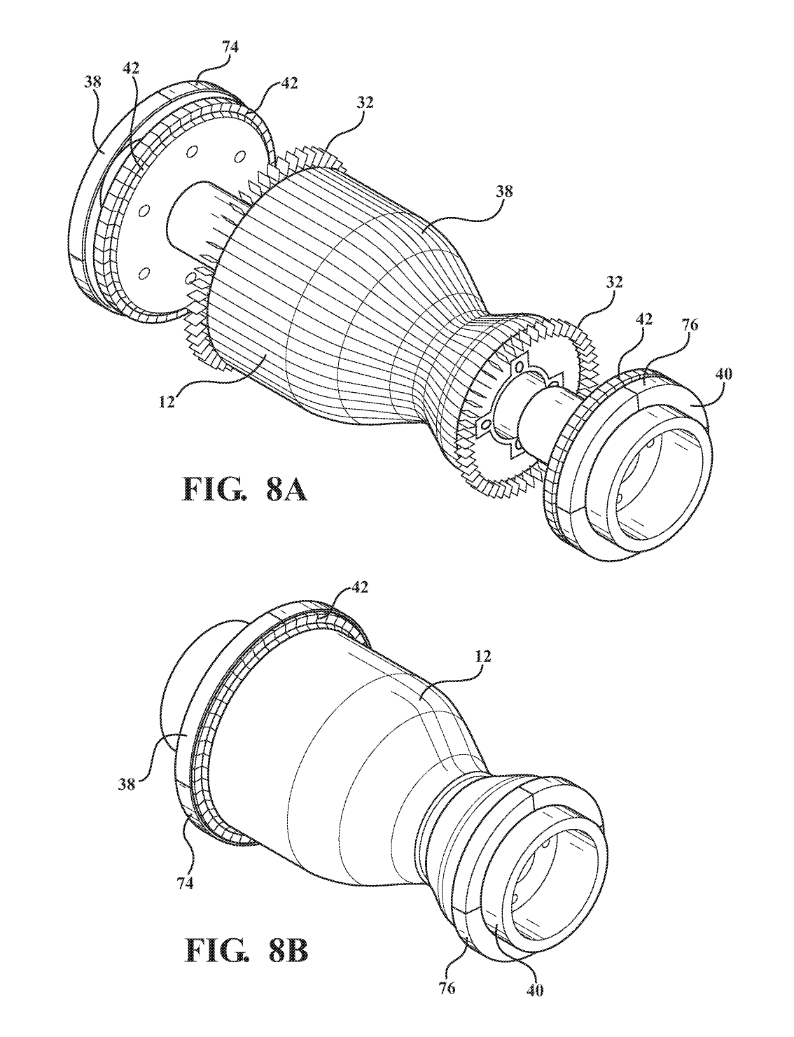

FIG. 8A is an exploded perspective view of the thrust chamber 10 having the core 36 within which secures the exoskeleton 18 in place during the step of dispensing/additive manufacturing. FIG. 8B is an isolated perspective view of the core 36 of FIG. 8A. The multi-piece core 36 of FIGS. 5A-5D is used. The embodiment of FIGS. 8A and 8B utilize the core 36 with the lower core portion 38 including the lower core retainer 74 having slots 42 which are configured to receive the ribs 32 of the endoskeleton 18. Referring again to FIG. 2, once the exoskeleton 18 is positioned, the method 8 further comprises the step of depositing the metallic material on the surface 16 of the base structure 12 having the exoskeleton 18 thereabout with an additive manufacturing process to form the additive structure 14 (2-6). FIG. 6A is a cross-sectional view taken across line B-B of FIG. 2, Step 6, and FIG. 6B is an isolated slice section view taken along line B-B of Step 6 of FIG. 2 with the base structure 12 having the exoskeleton 18 thereabout and the additive structure 14 disposed thereon.

As such, the core 36 can comprise one or more portions comprising different materials, and, as is shown, each portion can further comprise multiple pieces. The exemplary component 10 which is being formed in the Figures is a thrust chamber. However, depending on the shape of the base structure 12, the core 36 could be a single portion/piece core 36 including a fixture base or a thermal blanket carrier functioning as those shown in the embodiments described above. In other words, the shape of the base 12 of the thrust chamber 10 (in particular the shape of its chamber) necessitates a two portion/piece core (e.g. a core 36 having an upper and a lower core portion 38, 40).

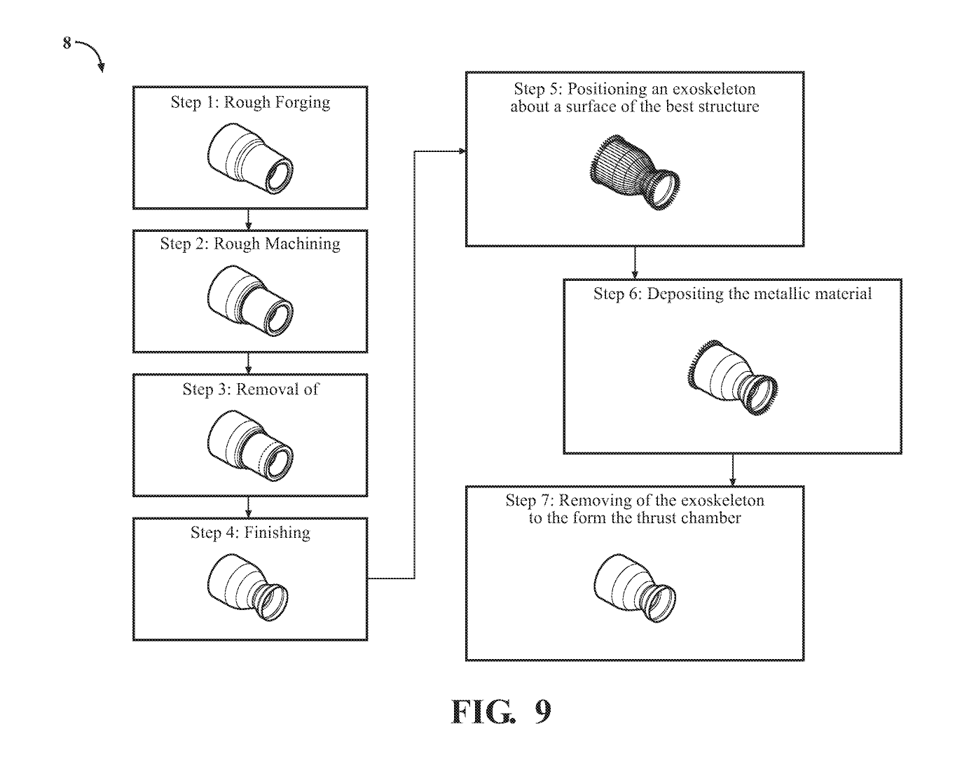

Referring again to FIG. 2, once the additive structure 14 is formed, the method 8 further comprises the step of removing the exoskeleton 18 to form the one or more cavities 20 (in this example, the one or more cavities 20 are cooling channels or passages). More specifically, in this embodiment, cooling channels 20′ within the thrust chamber 10 are formed to complete production of the component 10 (2-7). In a typical embodiment, the step of removing the exoskeleton 18 to form the component 10 is further defined as breaking and/or dissolving the exoskeleton 18. FIG. 7A is a cross-sectional view taken across line C-C of FIG. 2, Step 7, and FIG. 7B is an isolated slice section view taken along line C-C of Step 7 of FIG. 2. That is, FIG. 7B is an isolated slice section view taken along line C-C of the base structure 12 having the exoskeleton 18 removed and thus including cooling channels 20′, i.e., an isolated slice section view of the thrust chamber 10 formed with the method 8 shown in FIG. 2, Step 7. In the embodiment of FIG. 2, once the exoskeleton 18 is removed from the component 10 to form the one or more cavities 20 therein, the surfaces of the component 10 (including the surfaces created by or of the additive structure 14) are post processed. In many embodiments, the surfaces which define the one or more cavities 20 (cooling channels or passages) are surface treated via one or more of the following: detergent cleaning, solvent cleaning, mechanical cleaning, chemical cleaning, and priming. Even the surfaces which define the one or more cavities 20 can be surface treated. FIG. 9 is a flow chart which illustrates the process diagram of FIG. 2.

While the invention has been described with reference to the examples above, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all examples falling within the scope of the appended claims.

What is claimed is:

1. A method of producing a component comprises the steps of:
providing a base structure;
providing an exoskeleton;
positioning the exoskeleton about the surface of the base structure;
depositing a metallic material on the surface of the base structure having the exoskeleton thereabout with an additive manufacturing process to form an additive structure; and
removing the exoskeleton to form one or more cavities within the component and complete production thereof.

2. The method as set forth in claim 1, wherein the base structure comprises a metal selected from a copper or an alloy thereof, an Inconel alloy, and stainless steel.

3. The method as set forth in claim 1, wherein the step of providing the base structure includes the sub-steps of forging and machining a blank to form the base structure.

4. The method as set forth in claim 1, wherein the exoskeleton comprises ceramic and/or wire.

5. The method as set forth in claim 4 wherein a cross-sectional profile of the wire is rectangular.

6. The method as set forth in claim 4, wherein the step of removing the exoskeleton to form the component is further defined as breaking and subsequent removal of the exoskeleton that comprises ceramic and/or wire.

7. The method as set forth in claim 1, wherein the step of removing the exoskeleton to form the component is further defined as chemically breaking down or dissolving and subsequent removal of the exoskeleton to form one or more cavities within the component.

8. The method as set forth in 1 further comprising the step of polishing surfaces which define the one or more cavities with a polishing process selected from abrasive slurry polishing, chemical polishing, electro polishing, and combinations thereof.

9. The method as set forth in 1, wherein the steps of providing and positioning the exoskeleton are conducted concurrently with an additive manufacturing system, a three-dimensional printing process, or the like.

10. The method as set forth in 1, wherein the metallic material is selected from aluminum alloys, cobalt based alloys, tool steels, nickel based alloys, stainless steels, titanium based alloys, gold alloys, silver alloys, and copper alloys.

11. The method as set forth in claim 1, wherein the additive manufacturing process is a melting powder process comprising the steps of:
depositing the metallic material on a surface of the base structure and melting the metallic powder to form a layer of the metallic material, and
depositing a metallic powder on a surface of the layer and/or a surface of the exoskeleton and melting the metallic powder to form a subsequent layer of the metallic material,
wherein said second step is repeated one or more times to form the additive structure having a specific composition and geometry.

12. The method as set forth in claim 11, wherein the step of depositing and melting is conducted with one or more different types of metallic powder.

13. The method as set forth in claim 11, wherein the metallic material powder is deposited at a thickness of from about 20 to about 100 μm; and/or
has a mean particle size of from about 10 to about 50 μm.

14. The method as set forth in claim 11 further comprising:
the step of measuring the optical electromagnetic emissions of the melted metallic powder during the formation of each layer;
using an optical fiber probe to characterize each layer; and/or
taking an image of the melted metallic powder during the formation of each layer or each layer once formed.

15. The method as set forth in claim 11 further comprising the step of taking an image via scanning electron microscopy or computer tomography (“CT”) of the melted metallic powder during the formation of each layer or each layer once formed.

16. The method as set forth in claim 15, wherein the images are collectively used to characterize the porosity, cracking, grain, and homogeneity of the additive structure.

17. The method as set forth in claim 1, wherein the base structure is a tapered cylindrical structure having a front end and a back end, wherein the surface includes an outer peripheral surface and inner peripheral surface, wherein the inner peripheral surface defines a chamber.

18. The method as set forth in claim 17, wherein the step of positioning the exoskeleton about the surface of the base structure is further defined as positioning the exoskeleton about the outer peripheral surface of the base structure and inserting a core into the chamber, the core shaped to fit into the chamber and configured to be coupled to the exoskeleton and hold the exoskeleton in place during the additive manufacturing process and formation of the additive structure.

19. The method as set forth in claim 18, wherein
the core comprises two pieces configured to be coupled together and shaped to fit into the chamber; and/or the core comprises metal and ceramic.

20. The method as set forth in claim 1, wherein the exoskeleton includes a plurality of ribs configured to be positioning the exoskeleton about the surface of the base structure.

21. The method as set forth in claim 1, wherein the exoskeleton includes a plurality of linear and substantially parallel ribs configured to be positioned on the outer peripheral surface of the base structure, wherein, once positioned, the ribs extend from the front end to the back end of the base structure.

22. The method as set forth in claim 1, wherein a chamber portion of the exoskeleton extends around the front and back ends of the base structure and into the chamber.

23. A thrust chamber produced with the method as set forth in claim 1.
